(19) United States
(12) Patent Application Publication
(10) Pub. No.: US 2016/0311586 A1
(43) Pub. Date: Oct. 27, 2016

(54) DEVICE FOR DISPENSING FLUIDS SUITED TO BE APPLIED TO CONTAINERS AND RELATED DISPENSING SYSTEM

(71) Applicant: TAPLAST S.P.A.

(72) Inventor: Evans SANTAGIULIANA, Vicenza (VI) (IT)

(73) Assignee: TAPLAST S.P.A., Dueville - Povolaro (VI), OT (IT)

(21) Appl. No.: 15/103,903

(22) PCT Filed: Dec. 9, 2014
(86) PCT No.: PCT/IB2014/066717

§ 371 Date: Jun. 13, 2016

(30) Foreign Application Priority Data
Dec. 13, 2013 (IT) VI2013A000297

(51) Int. Cl. B65D 47/20; G01F 11/26; G01F 11/04

(52) U.S. Cl. CPC B65D 47/2062; G01F 11/04; G01F 11/263

(57) ABSTRACT

The invention is a device (1; 101; 201) for dispensing a fluid (F) suited to be applied to a container (70) containing the fluid (F), comprising: a hollow body (10; 10; 10″) defining a chamber (11) suited to receive and/or allow the transit of a given quantity of the fluid (F) and a first opening (12; 12; 12″; 112) suited to place the chamber (11) in communication with the inside of the container (70) and to allow the passage of the fluid (F); a dispensing mouth (15) suited to dispense said fluid (F); a thrusting element (16; 80; 90; 95; 1 16) slidingly coupled in the chamber (11) and movable along a direction of movement (X) from a first rest position to a second operating position in order to convey the entirety or part of the quantity of fluid (F) from the chamber (11) towards the dispensing mouth (15). Said thrusting element (16; 80; 90; 95; 116) comprises a confinement area (20; 81; 91; 96) of a substance different from the fluid (F). The invention concerns also a system for dispensing a fluid (F).

### FIELD OF APPLICATION OF THE INVENTION

The present invention is related to the technical field of systems for dispensing products, particularly suited to dispense fluids like detergents in general or food substances.

In particular, the present invention concerns a device for dispensing a fluid that is suited to be applied to a container holding said fluid.

The invention also refers to a dispensing system or set comprising said container and the device for dispensing said fluid.

### DESCRIPTION OF THE STATE OF THE ART

In the field of systems for dispensing fluids, meaning liquid or creamy products such as soaps, creams, detergents or food substances, the use of dispensing devices that are applied to the container holding said products is known.

These dispensing devices are applied to collapsible/deformable containers, typically made of plastic, which must be pressed with a hand in order to allow the product to be dispensed.

These dispensing devices substantially serve both as closing caps for the container and as devices for dispensing a predefined quantity of fluid from the inside of the container towards the outside.

In some dispensing systems of the known type the container is arranged in the upturned position, meaning with the fluid outlet area in a lower position with respect to the volume enclosed by the container and therefore with the dispensing device facing downwards.

The predefined quantity of fluid is dispensed when the user exerts a pressure on the deformable container. For this purpose, the dispensing devices of the known type are made in such a way as to allow the desired quantity of fluid to be dispensed while the container is being pressed and to successively stop the flow of the fluid from the inside of the container once the user has released the previously deformed walls of the container.

Dispensing devices of the known type that make it possible to perform said dispensing steps typically comprise an intermediate chamber suited to hold a predefined quantity of fluid received from the container, wherein said fluid is expelled towards the outside, while the container is being pressed, through a suitable opening present in the device itself. During said pressing step performed by the user, a thrusting force is in turn applied to the intermediate chamber in order to thrust the predefined quantity of fluid contained therein by means of a piston properly housed in the intermediate chamber.

At the end of the dispensing operation and following the release of the container by the user, the piston is automatically brought back to its initial position and the intermediate chamber is ready to be filled again with a new predefined quantity of fluid for the successive dispensing operation.

In order to ensure that the several operating steps of the dispensing device are properly carried out, suitable valve means are provided that are suited to adjust and synchronize the correct passage of fluid from the container into the intermediate chamber and from the intermediate chamber towards the outside.

The dispensing systems belonging to the state of the art, however, pose some drawbacks.

A first drawback posed by said dispensing systems or sets is represented by the construction complexity of the dispensing device which includes a large number of components.

This results in high costs and/or long production times.

Another drawback posed by said dispensing systems or sets of the known type is constituted by the fact that the dispensing devices are rather large.

Consequently, the product is rather bulky, which is an undesired feature, and a considerable quantity of raw material is needed to make it, which, once again, results in high production costs.

It is therefore evident from the above that there is the need to identify alternative solutions which are more functional than the known solutions.

The main object of the present invention is therefore to solve or at least partially overcome the problems that characterize the solutions known in the art.

In particular, it is a first object of the invention to provide a dispensing system that is simpler to construct compared to the systems of known type.

It is another object of the invention to provide a dispensing system having lower production costs compared to the systems of known type.

It is another object of the invention to provide a dispensing system that, in the same conditions, has smaller overall dimensions than the systems of known type.

It is a further object of the invention to provide a dispensing system that makes it possible to reduce weights compared to the systems of known type.

It is another object of the invention to provide a dispensing system that is capable of completely emptying the fluid container in a correct manner, without leaving residues of unused product.

It is a further object of the invention to provide a dispensing system that makes it possible to reduce the overall dimensions of that portion of the dispensing device that is inside the container, in order to increase the volume to be filled with fluid compared to the volume available in the systems of known type.

### SUMMARY OF THE PRESENT INVENTION

The present invention is based on the general concept that it is possible to provide a system for dispensing a fluid comprising a deformable container and a dispensing device suited to be applied to said deformable container, wherein said system can be carried out in a simple manner.

The present invention is also based on a further general consideration, according to which it is possible to provide a fluid dispensing system comprising a deformable container and a dispensing device suited to be applied to said deformable container, the latter being provided with a chamber suited to receive a given quantity of fluid and/or allow the transit of the same through a dispensing mouth, as well as a thrusting element suited to thrust the fluid from said chamber towards said dispensing mouth, and wherein said thrusting element is configured in such a way that it behaves as a floating element with respect to the fluid to be dispensed.

According to a first aspect of the invention, therefore, the subject of the same is a device for dispensing a fluid suited to be applied to a container holding said fluid, said device comprising:
a hollow body that defines at least one chamber suited to receive and/or allow the transit of a given quantity of said fluid and at least one first opening suited to allow said chamber to be in communication with the inside of said container and to allow said fluid to flow therethrough;
a dispensing mouth suited to dispense said fluid;
a thrusting element slidingly coupled in said chamber and movable along a direction of movement from at least one first rest position to at least one second operating position in order to thrust the entirety or part of said given quantity of fluid from said chamber towards said dispensing mouth, said thrusting element comprising at least one confinement area in which a substance that is different from said fluid is confined.

The density of said substance is preferably lower than the density of the fluid to be dispensed.

In one of its preferred embodiments, said substance is a gaseous substance, preferably air.

In a different preferred embodiment, said substance is constituted by a liquid.

Preferably, the confinement area comprises a concave surface of the thrusting element.

In a preferred embodiment of the invention, said confinement area is constituted by a closed volume. Advantageously, said closed volume comprises a concave surface and a closing element suited to close said concave surface.

Preferably, the hollow body comprises at least one second opening that places said chamber in communication with the container.

In a preferred embodiment of the invention, said second opening is circular.

In one of its preferred embodiments, the thrusting element comprises a first part that is slidingly coupled in the second opening present in the hollow body and a second part that is slidingly coupled in said chamber, said first part of the thrusting element sliding in the second opening present in the hollow body when the thrusting element is moved along the direction of movement.

Advantageously, the first part of the thrusting element is cylindrical.

In a preferred embodiment of the invention, the first part of the thrusting element is hollow and said confinement area is defined inside it. More preferably, in this case, the first part of the thrusting element comprises a hollow cylinder.

Preferably, the shape of the second part of the thrusting element matches the shape of the chamber defined by the hollow body. More preferably, said chamber is substantially cylindrical in shape. Preferably, the second part of the element has a circular profile.

The surface area of the second opening of the hollow body is conveniently larger than the surface area of the first part of the thrusting element, said surface areas being measured on a plane perpendicular to the direction of movement of the thrusting element.

In a preferred embodiment of the invention, the second operating position of the thrusting element is an end-of-stroke position of the thrusting element itself.

Preferably, in said end-of-stroke position the thrusting element intercepts the dispensing mouth.

In a variant embodiment of the invention, in the end-of-stroke position the thrusting element intercepts the first opening.

Preferably, the thrusting element substantially comprises a piston.

The device according to the invention preferably comprises connection means suited to ensure connection to the container.

Furthermore, the device according to the invention preferably comprises means for closing the dispensing mouth. Said closing means preferably comprise a cover.

Preferably, the device according to the invention also comprises anti-dripping means suited to allow the dispensing mouth to be closed when the thrusting element is in the first rest position.

According to another aspect of the present invention, its subject includes a system for dispensing a fluid comprising a container for said fluid and a device for dispensing said fluid, wherein said device is suited to be applied to said container, and wherein said device is carried out according to the description provided above.

Preferably, the container is of the collapsible and/or deformable type.

### BRIEF DESCRIPTION OF THE DRAWINGS

Further advantages, objects and characteristics, as well as further embodiments of the present invention are defined in the claims and will be illustrated in the following description, with reference to the enclosed drawings; in the drawings, corresponding or equivalent characteristics and/or component parts are identified by the same reference numbers. In particular:

FIG. 1 shows a side view of a device for dispensing a fluid associated with a container in order to provide a dispensing system according to a preferred embodiment of the invention;

FIG. 2 shows a view from below of the system shown in FIG. 1;

FIG. 3 shows an exploded view of the dispensing system of FIG. 1;

FIG. 4 shows a partial longitudinal sectional view along section plane IV-IV of the dispensing system of FIG. 2 in a first operating position;

FIG. 5 shows a top view of an enlarged detail of some elements of the system shown in FIG. 4;

FIG. 6 shows a sectional view of FIG. 5 along section plane VI-VI;

FIG. 7 shows a longitudinal sectional view of the system of FIG. 3;

FIG. 8 shows the longitudinal sectional view of the system of FIG. 4 in a different working position during operation;

FIG. 9 shows the longitudinal sectional view of the system of FIG. 4 in a different working position during operation;

FIG. 10 shows the longitudinal sectional view of the system of FIG. 4 in a further working position during the release step;

FIG. 11 shows the elements of FIG. 5 according to a variant embodiment of the present invention;

FIG. 12 shows a sectional view of FIG. 11 along section plane XII-XII;

Figures from 13 to 15 show variant embodiments of an element of the dispensing device according to the present invention;

FIG. 16 shows a variant embodiment of an element of the dispensing system of FIG. 3;

FIG. 17 shows a sectional view of the element shown in FIG. 16;

FIG. 18 shows a variant embodiment of the element of FIG. 16;

FIG. 19 shows a plan view of the embodiment of FIG. 18;

FIG. 20 shows a variant embodiment of FIG. 4;

FIG. 21 shows the longitudinal sectional view of the system of FIG. 20 in a different working position during operation;

FIG. 22 shows the longitudinal sectional view of the system of FIG. 20 in a different working position during operation;

FIG. 23 shows a variant embodiment of FIG. 20;

FIG. 24 shows the longitudinal sectional view of the system of FIG. 23 in a different working position during operation;

FIG. 25 shows the longitudinal sectional view of the embodiment of FIG. 23 in a different working position during operation.

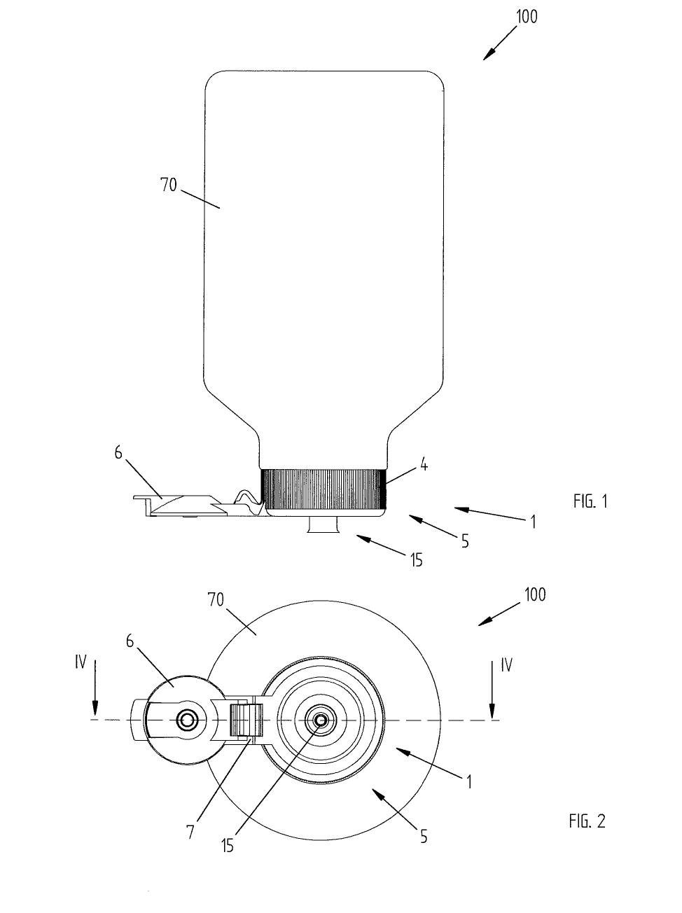

### DETAILED DESCRIPTION OF THE PRESENT INVENTION

In the following description related to the figures, some particular embodiments of the present invention will be illustrated but, obviously, the present invention is not limited to said particular embodiments; rather, the particular embodiments described below clarify various aspects of the present invention, the object and the scope of which are defined by the claims.

The example of embodiment of the invention described here below refers to a system for dispensing a fluid product such as a detergent, more preferably a creamy fluid.

It is clear that the solution proposed can be applied also to systems for dispensing different products, for example food products or any other fluid in general, preferably creamy or liquid, that must be drawn from a container and conveyed towards the outside in specific predefined quantities.

A non-limiting example of embodiment of a dispensing device that is the subject of the present invention, associated with a container in order to obtain a dispensing system or set that is also the subject of the present invention, is shown in FIG. 1.

More particularly, the dispensing system indicated as a whole by 100 comprises a container 70 and a dispensing device 1 associated with it.

The container 70 is preferably collapsible and/or deformable and suited to hold a fluid F to be dispensed.

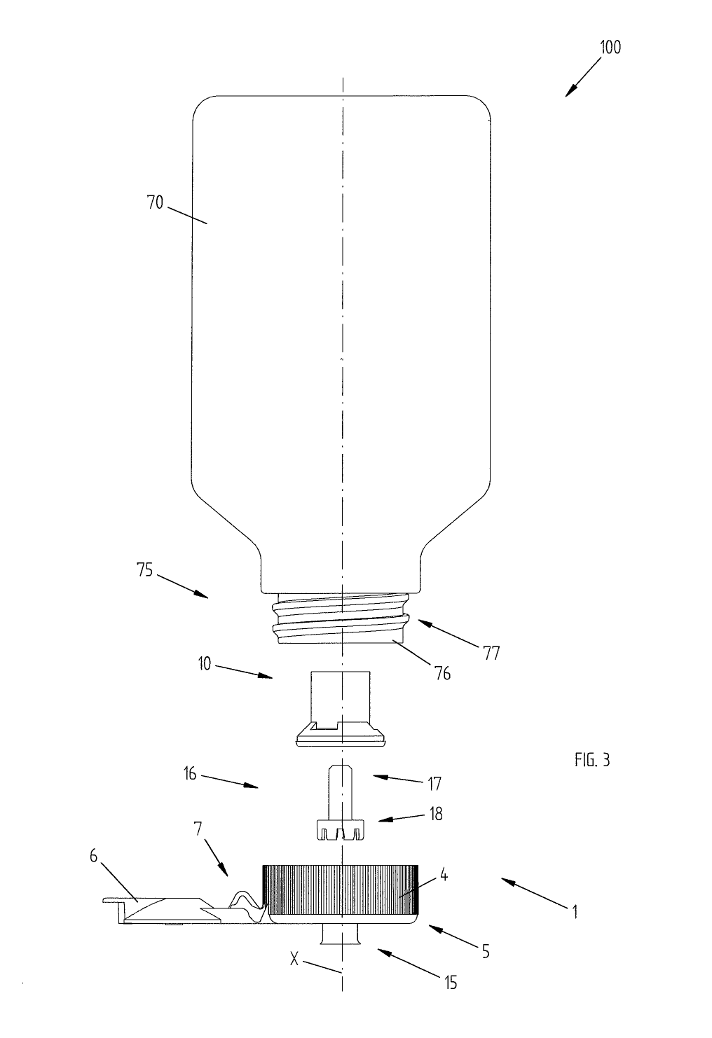

The container 70 is advantageously provided with connection means 75 for connection to the dispensing device 1, better visible in FIG. 3. In the embodiment illustrated herein, the connection means 75 comprise a tubular element or neck 76 provided with a threaded edge 77. Said threaded edge 77 is suited to be coupled with a corresponding threaded profile 2 belonging to the dispensing device 1, so that the dispensing device 1 can be associated with the container 70 through a screwing operation. It is clear, however, that said connection means 75 can be made in different shapes, compatible with the shape of the connection area between the container and the dispensing device. For example, the threaded profiles can be replaced by any type of connection system of the known type, such as bayonet or snap or pressure systems.

In the various assembly figures, the container 70 and the dispensing device 1 are shown in their preferred configuration of use, meaning with the dispensing device 1 arranged under the container 70 in order to make the fluid flow out downwards, that is, upturned.

Concerning the dispensing device 1, first of all this comprises connection means 3 for connection to the container 70. In the embodiment described herein and according to that which has been explained above, the connection means 3 comprise a threaded profile 2.

The threaded profile 2 is advantageously made in an annular portion or metal ring 4. It is clear, analogously to that which has been described above, that the connection means 3 can be made in different shapes, compatible with the shape of the connection area between the container and the dispensing device, for example bayonet or snap or pressure systems.

The dispensing device 1 comprises a main body 5 on which said metal ring 4 is defined, among other things, together with a dispensing mouth 15 suited to dispense the fluid F.

The dispensing device 1 also comprises, preferably, a movable element or cover 6 suited to intercept the dispensing mouth 15.

In the embodiment illustrated herein, the cover 6 is made in a single piece with the main portion 5 and can be rotated around the same by means of a hinge 7.

The hinge 7 is preferably obtained during the production of the dispensing device 1 itself, preferably through a plastic material moulding step.

The cover 6, therefore, can be comfortably arranged in open position, as shown for the sake of simplicity in the various figures, or in closed position, so as to intercept the dispensing mouth 15 and thus close the dispensing system 100 when the same is not used.

In different embodiments, the cover can be made in a different way, for example it can constitute a separate element with respect to the main body 5 and, in a limit case, it can even be absent.

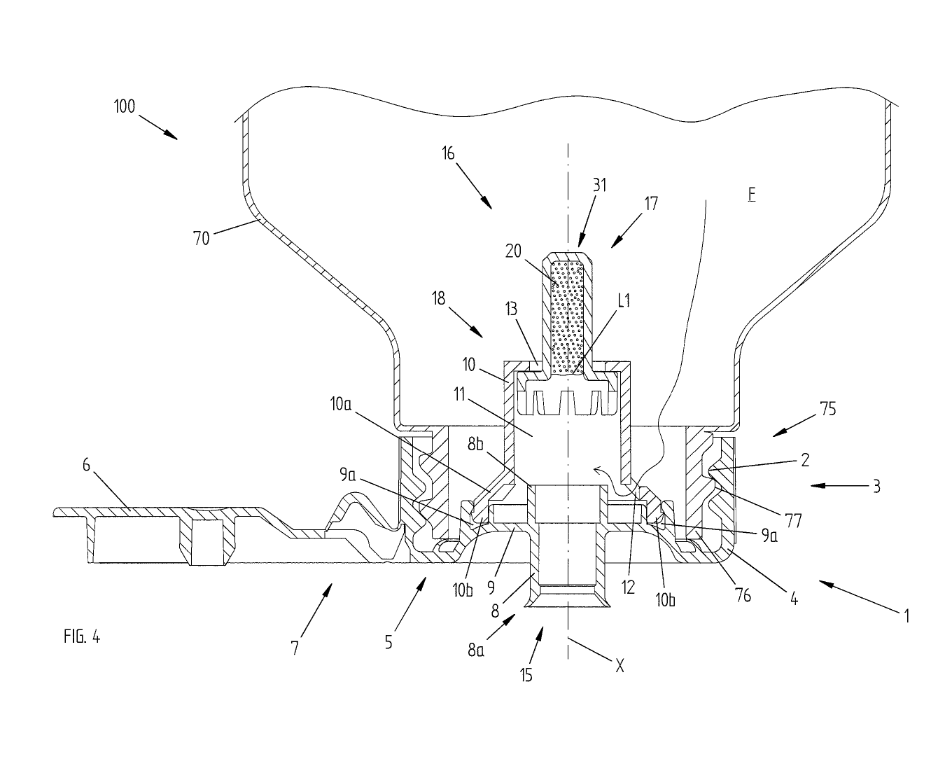

The dispensing mouth 15 suited to dispense the fluid F is preferably defined by a tubular portion 8 that extends from an outer edge 8a to an inner edge 8b, as shown in FIG. 4.

Said tubular portion 8 and the corresponding edges 8a, 8b preferably have a circular cross section.

The tubular portion 8 is substantially arranged in central position in the main body 5 and forms a single body with the external metal ring 4 through an annular connection area 9.

The annular compression area 9 is preferably associated with a hollow body 10.

The hollow body 10 and a part of the annular connection area 9 define a chamber 11 inside which the tubular portion 8 ends with its inner edge 8b.

The hollow body 10 is preferably cylindrical in shape, with a slightly tapered, preferably truncated cone-shaped terminal area 10a.

The hollow body 10 is preferably associated with the annular connection area 9 in a removable manner. In the embodiment illustrated herein, said connection is obtained by snap-fitting an edge 10b of the hollow body 10 in a corresponding annular seat 9a created in the connection area 9.

It is evident that in variant embodiments said connection can be obtained in a different manner, for example by glueing, heat sealing, etc.

The chamber 11 defines a volume holding and/or allowing the transit of a given quantity of the fluid F coming from the inside of the container 70 and intended to be dispensed towards the outside through the dispensing mouth 15, that is, through the tubular portion 8 (as is described in detail below).

The hollow body 10 comprises, first of all, a first opening 12 suited to place said chamber 11 in communication with the inside of said container 70. In the embodiment illustrated herein, the first opening 12 preferably comprises three slots that develop circumferentially in the hollow body 10, preferably each for a sector with amplitude equal to 50°.

In particular, from the inside of the container 70 the fluid F can reach the chamber 11 through the first opening 12.

In variant embodiments, the first opening 12 can assume different shapes and/or positions on the hollow body 10.

For this purpose and by way of example, Figures from 16 to 19 show two variant embodiments of the hollow body 10′, 10″.

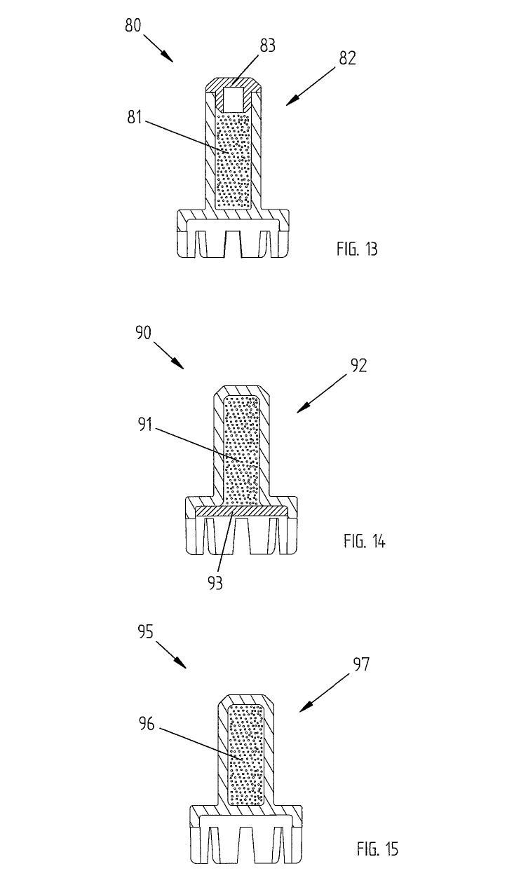

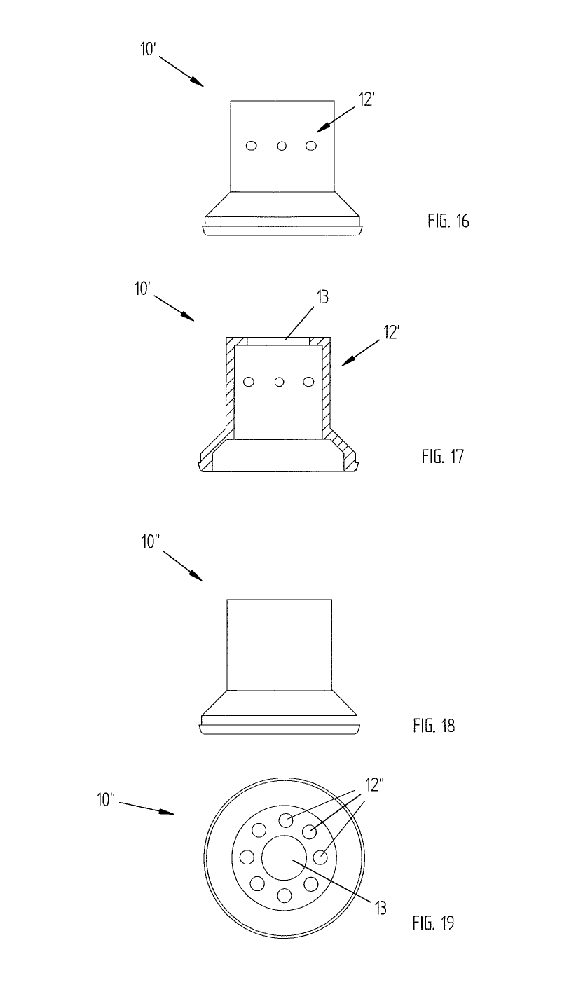

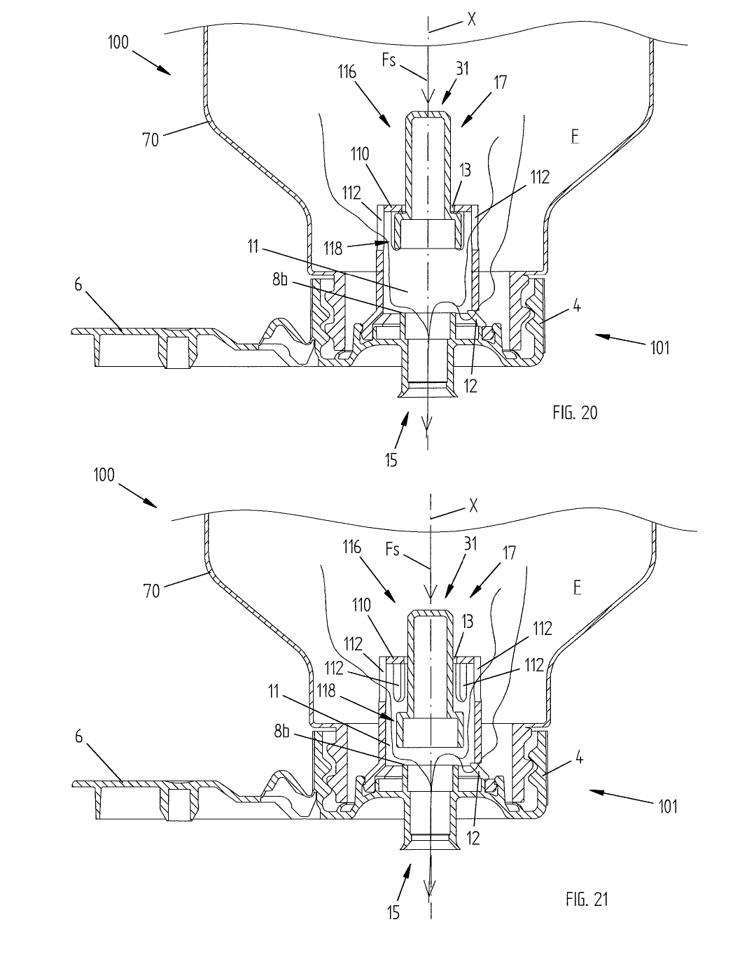

In FIGS. 16 and 17 the hollow body 10′ comprises a plurality of circular openings 12′ arranged on the lateral surface of the hollow body 10′ itself.

In FIGS. 18 and 19 the hollow body 10″ comprises a plurality of circular openings 12″ arranged above the hollow body 10″ itself.

The hollow body 10 comprises also a second opening 13 that communicates with the inside of the container 70.

The second opening 13 is preferably circular in shape.

The dispensing body 1 furthermore comprises a thrusting element 16 that is coupled with said hollow body 10. The thrusting element 16 and the hollow body 10 are configured in such a way that the thrusting element 16 can be moved along a direction of movement X from at least one first rest position, shown for example in FIG. 4, to at least one second operating position, shown for example in FIG. 8 or 9, as is explained in greater detail below.

During its movement, the thrusting element 16 preferably slides inside the second opening 13 of the hollow body 10. During its movement from the rest position along the direction of movement X, the thrusting element 16 conveys the fluid present in the chamber 11 towards the outside through the dispensing mouth 15, as is explained in greater detail below.

The thrusting element 16 preferably comprises a first part 17 with mainly longitudinal development, suited to be housed and slide into the second opening 13 of the hollow body 10 and a second terminal part 18 suited to be housed and slide into the chamber 11 defined in the hollow body 10.

The first part 17 of the thrusting element 16 is preferably cylindrical in shape.

The shape of the second part 18 of the thrusting element 16 preferably matches the shape of the chamber 11, said shape being preferably circular.

The thrusting element 16 has substantially the shape of a piston.

Preferably, furthermore, the coupling between the second part 18 of the thrusting element 16 and the chamber 11 is as precise as possible, in such a way as to reduce the space between them to a minimum.

However, in variant embodiments the shape of the second part 18 of the thrusting element 16 and the shape of the chamber can be selected in a different manner, for example their shapes may not match each other. Furthermore, their mutual coupling does not necessarily need to be precise, as illustrated below, for example, with reference to the embodiment shown in Figures from 20 to 22.

According to an aspect of the present invention, the thrusting element 16 is shaped in such a way as to define a confinement area 20 that encloses air.

In the embodiment illustrated herein, said confinement area 20 is preferably constituted by the inner area of the first part 17, meaning in particular the inner area of the cylindrical portion that defines said first part 17.

Inside the confinement area 20, the confined air defines an air space. The fluid F does not occupy that confinement area 20 and, instead, reaches a pre-determined lower level approximately indicated by L1 in FIG. 4.

In the upturned configuration of the dispensing system 100, as shown in the figures, the thrusting element 16 with the air confined inside it in the confinement area 20 substantially operates as a floating element.

The resulting advantageous effect is described here below with reference to the dispensing steps through which the fluid F is dispensed by means of the dispensing system 100.

FIG. 4 shows the dispensing system 1 in upturned position ready for the dispensing process, or rest position.

In this condition the thrusting element 16, due to its floating condition, is positioned at the top with the first part 17 completely projecting from the second opening 13 of the casing 10 towards the inside of the container 70.

The inside of the chamber 11 of the casing 10 is filled with a predefined quantity of fluid F.

This fluid flows from the first opening 12 by gravity or is the residue of the final step of a previous dispensing operation, as is better explained below.

In this operating condition a small quantity of fluid F may flow out of the dispensing mouth 15. However, due to the inherent viscosity of the fluid F, this outflow is minimal with a slight dripping or may even be absent if the fluid is very viscous.

Variant embodiments of the invention may be provided with an anti-dripping system, as is described below with reference to Figures from 23 to 25.

In order to start dispensing the fluid, the user squeezes the deformable walls of the container 70 and exerts a given pressure on the fluid F held inside the container 70.

During this step, illustrated in FIG. 8, the thrusting element 16 is moved downwards along the direction of movement X due to the effect of the thrusting force Fs exerted from above by the fluid F under pressure.

At the same time, part of the fluid F flows into the chamber 11 through the first opening 12.

From the chamber 11, the fluid is conveyed and dispensed towards the outside through the dispensing mouth 15.

The dispensing step preferably ends when the thrusting element 16 reaches its end-of-stroke position shown in FIG. 9.

In this end-of-stroke position the thrusting element 16 intercepts the inner edge 8b of the tubular element 8 closing the dispensing mouth 15 and interrupting the dispensing operation (of the fluid F).

During the dispensing step, therefore, the fluid F present in the chamber 11 that flowed through the same coming from the first opening 12 has been dispensed towards the outside.

It is evident that if the user releases the container 70 before the thrusting element 16 has reached said end-of-stroke position, the dispensed quantity of fluid will be smaller than in the case described above.

In variant embodiments of the invention, in the end-of-stroke position the thrusting element may intercept and thus close the first opening 12 of the hollow body 10 instead of the dispensing mouth 15. In any case, in this condition the dispensing operation (of the fluid F) is interrupted.

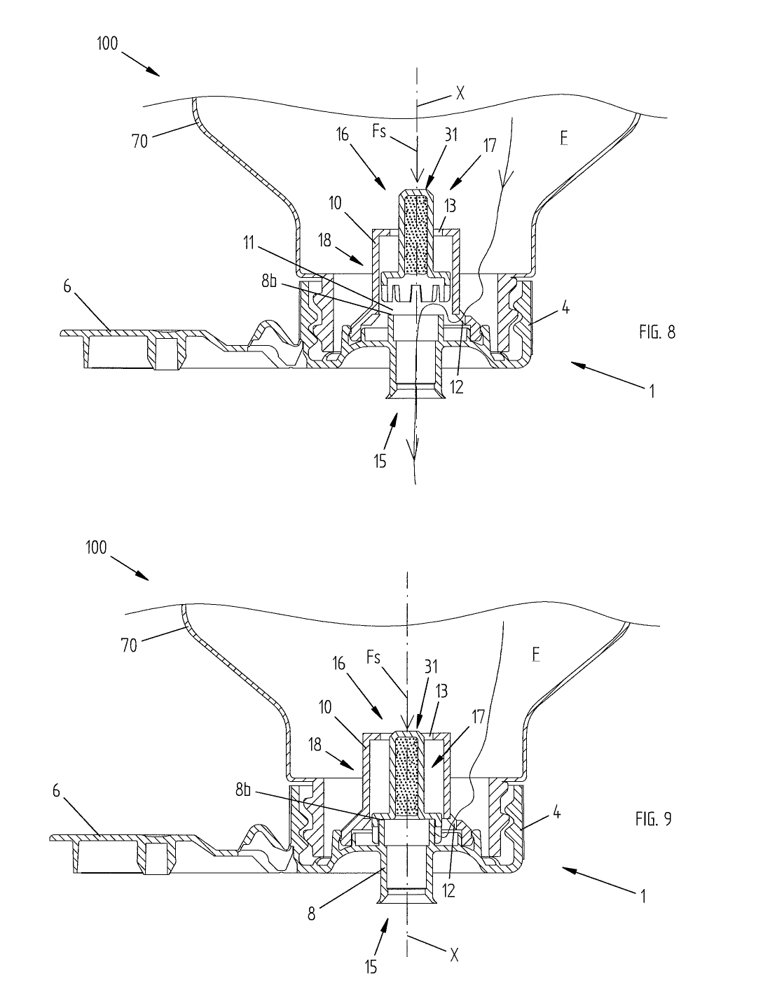

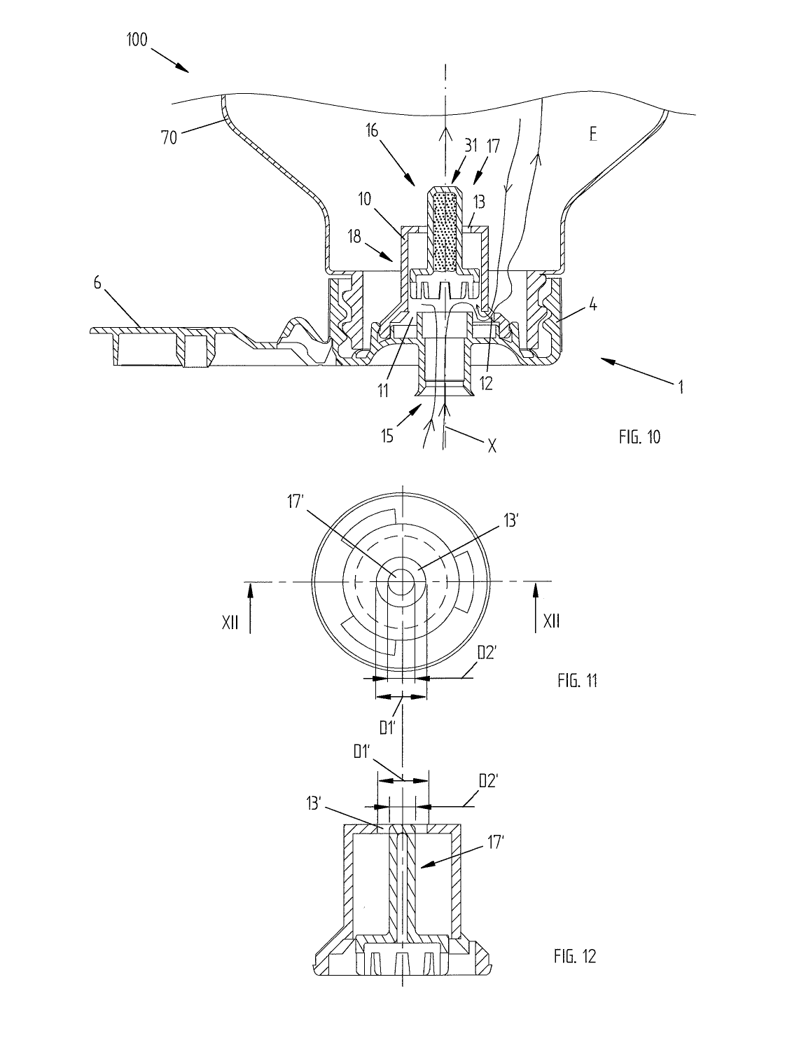

In the moment when the user releases the container 70, the thrusting force Fs is not exerted on the thrusting element 16 any longer. From this moment onwards, thanks to its floating condition, the thrusting element 16 tends to automatically move back towards its upper rest position, as shown in FIG. 10. The return to the upper rest position is facilitated and quickened by the presence of the air that is sucked in from the outside through the dispensing mouth 15 during the release of the container 70.

During this step the air is sucked from the outside into the chamber 11 through the dispensing mouth 15. Part of this air can reach the inside of the container 70 through the first opening 12 and at the same time a quantity of fluid F flows into the chamber 11 through the same first opening 12.

At the end of the release step, the thrusting element 16 will move back to the initial position, that is, the position shown in FIG. 4, and the dispensing system 100 will be ready for a new dispensing operation.

It should be noted that during the various steps described above, in any case, the air is always maintained inside the confinement area 20 of the thrusting element 16.

This allows the thrusting element 16 to behave as a floating element and operate as described above.

This floating effect is obtained, in particular, thanks to the lower density of the air trapped in the confinement area 20 compared to the density of the surrounding fluid F.

Thanks to the floating effect of the thrusting element 16, therefore, in the dispensing device 100 the initial condition, meaning the condition shown in FIG. 4, is automatically restored for the successive dispensing operations.

Therefore, the dispensing device does not need special mechanisms, for example valve means or elastic means, as in the case of the known systems. Its construction is advantageously simplified and requires the assembly of two pieces only (the hollow body 10 and the thrusting element 16) on the first portion 5 that constitutes the dispensing device 1.

Consequently, the quantity of material necessary for its construction is reduced, and this results in reduced production costs, in terms of both raw materials used and construction and/or assembly time, compared to the systems of known type.

Also the weight will be reduced compared to the weight of the devices of known type.

A further characteristic of the dispensing system 100 described herein derives from the mutual shape of the second opening 13 of the casing 10 and of the first part 17 of the thrusting element 16 that slides into it.

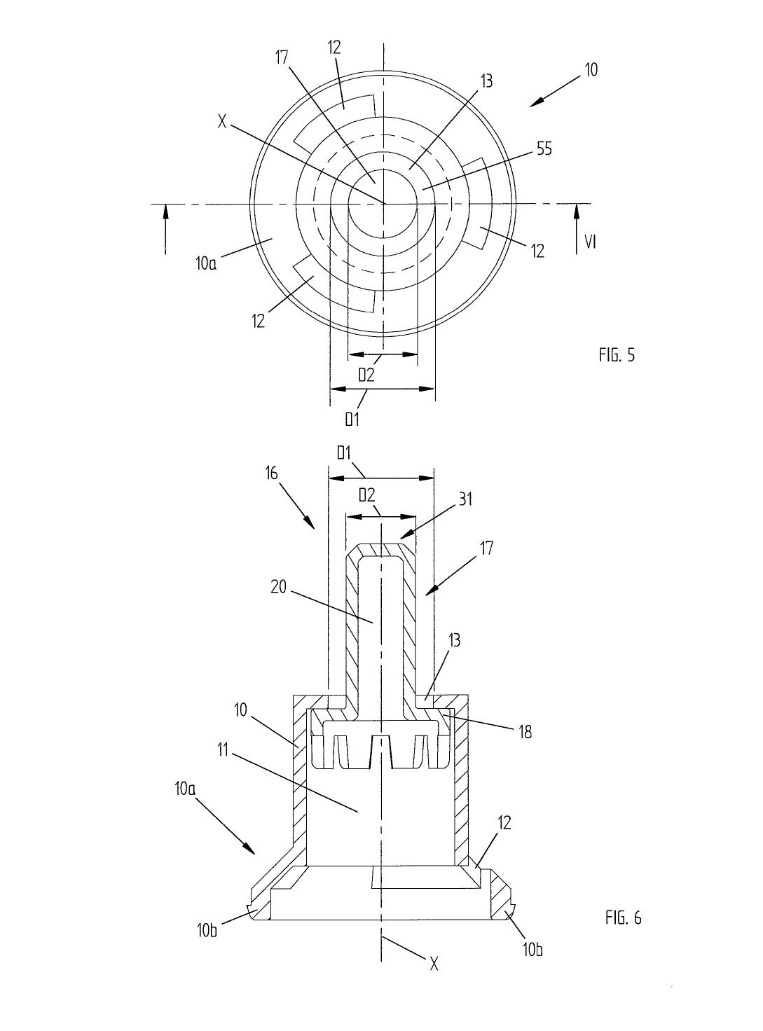

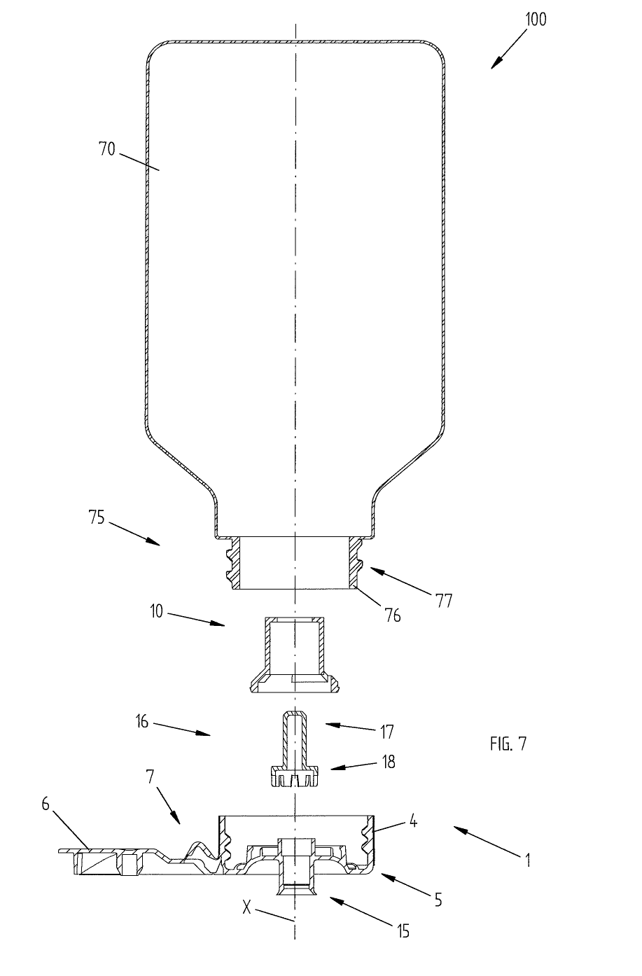

In particular, as can be observed in FIGS. 5 and 6, the second opening 13 is circular and has a given diameter D1. Said second opening 13, therefore, defines a surface area A1, in the case at hand the surface area of the circle with diameter D1.

Said surface area A1 can be identified on a reference plane constituted by a plane perpendicular to the direction of movement X.

Independently of the shape of the second opening 13, this will define a predetermined surface area A1 on said plane.

Analogously, the first part 17 of the thrusting element 16 has a circular cross section and a given diameter D2, in particular in its terminal area 31 on which, as previously described, the thrusting force Fs of the fluid F is exerted. This terminal area 31 therefore defines a predetermined surface area A2, in the case at hand the surface area of the circle with diameter D2.

Said surface area A2, too, can be identified on a reference plane constituted by a plane perpendicular to the direction of movement X.

Independently of the shape of the first part 17, this will thus define a predetermined surface area A2 on said plane.

According to the present invention, the surface area A1 of the second opening 13 will be larger than the surface area A2 of the second part IT of the thrusting element 16, as the latter must slide inside the second opening 13.

The difference between the two surface areas, A1-A2, which in the case at hand corresponds to an annular area 55, directly affects the speed of movement of the thrusting element 16 during the dispensing step and therefore the speed at which the predefined quantity of fluid F is dispensed from the inside of the chamber 11 towards the outside.

The speed of movement of the thrusting element 16 during the dispensing step in turn affects the quantity of fluid F that is dispensed and also the speed at which the thrusting element 16 returns to its rest position, and therefore the time necessary to restore the initial condition of the dispensing system 100, as is better explained below.

Therefore, by acting on the size of the second opening 13 and of the first part 17 of the thrusting element 16 it is possible to adjust the speed at which the predefined quantity of fluid F is dispensed and/or the quantity dispensed and/or the time necessary to restore the initial condition of the system 100.

For example, by increasing the diameter D1 of the second opening 13, thus increasing the corresponding surface area A1, and maintaining a constant value for the diameter D2 of the first part 17 of the thrusting element 16, therefore maintaining the surface area A2 constant, a higher speed of movement of the thrusting element 16 will be achieved.

Vice versa, by reducing the diameter D1 of the second opening 13, thus reducing the corresponding surface area A1, and maintaining a constant value for the diameter D2 of the first part 17 of the thrusting element 16, therefore maintaining the surface area A2 constant, a lower speed of movement of the thrusting element 16 will be achieved.

FIGS. 11 and 12 show a variant embodiment of the invention in which the sizes D1′ and D2′ of the second opening 13′ and of the second part 17′ of the thrusting element 16′ define corresponding surface areas A1′ and A2′ whose difference A1′-A2′ is smaller compared to the case previously described above.

Figures from 13 to 15 show some variant embodiments of the thrusting element of the dispensing device that is the subject of the present invention. These variant embodiments differ from the embodiment described above due to the different configuration of the confinement area.

In particular, in FIG. 13 the thrusting element 80 comprises a closed confinement area 81 preferably defined in the cylindrical portion of the the first part 82. In particular, the confinement area 81 is closed at the top by a closing element 83 suited to be applied to the first part 82.

In this embodiment, to advantage, the confinement area 81 is sealed and the space enclosed by it is defined in a univocal manner. Therefore, also the floating condition of the thrusting element 80 is ensured and defined in a precise manner, maintaining and guaranteeing the same functional characteristics over time.

Furthermore, the possibility to close the top of the confinement area 81 by means of the closing element 83 makes it possible to fill the confinement area 81 with a substance different from air.

For example, the confinement area 81 may be filled with a gas having a lower density than air in order to improve the floating effect of the thrusting element 80, or it may be filled with a different, non-gaseous fluid, taking care that its density is lower than that of the fluid F to be dispensed. This will guarantee the floating condition of the thrusting element 80.

In FIG. 14 also the thrusting element 90 comprises a closed confinement area 91 preferably defined in the cylindrical portion of the the first part 92. In particular, the confinement area 91 is closed at the bottom by a closing element 93 suited to be applied to the inside of the first part 92.

Preferably, the closing element 93 is made in a rubber material in order to guarantee the sealing of the confinement area 91. Furthermore, the closing element 93 guarantees a neater cut of the flow when the closing element is placed in contact with the inner edge 8b of the dispensing mouth 15.

The explanation provided above with reference to the embodiment of FIG. 13, with the corresponding advantages, applies also to this embodiment.

In FIG. 15 also the thrusting element 95 comprises a closed confinement area 91 preferably defined in the cylindrical portion of the the first part 97. In particular, the confinement area 96 is obtained as a single piece during the making of the thrusting element 95.

Figures from 20 to 22 show a dispensing system 100 comprising a dispensing device 101 according to a variant embodiment of the invention.

This embodiment differs from the embodiment described above with reference to Figures from 1 to 10 due to the fact that the hollow body 110 comprises a further plurality of openings 112 arranged on the lateral surface of the hollow body 110 itself and due to the fact that the shape of the second terminal part 118 of the thrusting element 116 does not match the shape of the chamber 11, that is, it is smaller.

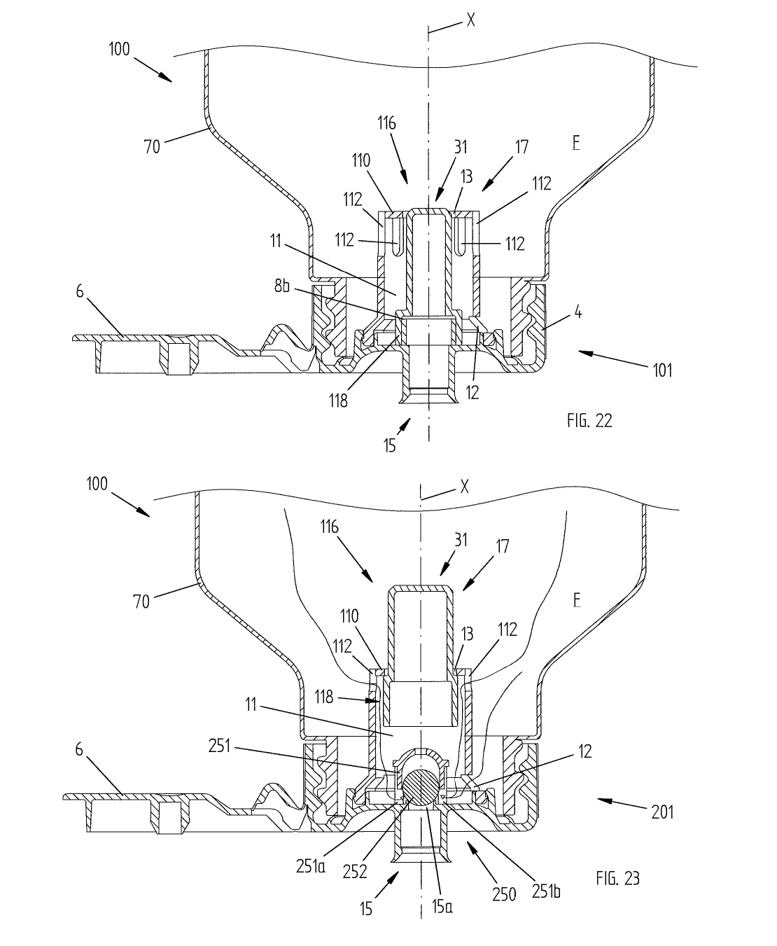

The hollow body 110 and the thrusting element 116 shaped in this way determine a different behaviour during the operation of the dispensing system 100, as shown in particular in FIGS. 21 and 22.

During the dispensing operation the thrusting element 116 is moved downwards along the direction of movement X due to the effect of the thrusting force Fs exerted from above by the fluid F under pressure.

At the same time, part of the fluid F flows into the chamber 11 through both the first opening 12 and the further plurality of openings 112 present in the hollow body 110. The fluid F flowing in through said further plurality of openings 112 reaches the chamber 11 thanks to the reduced size of the second terminal part 118 of the thrusting element 116 compared to the chamber 11.

From the chamber 11, the fluid is conveyed and dispensed towards the outside through the dispensing mouth 15.

The dispensing step preferably ends when the thrusting element 116 reaches the end-of-stroke position shown in FIG. 22.

During the dispensing step, therefore, the fluid F present in the chamber 11 that flowed through the same coming from the first opening 12 and the openings 112 has been dispensed towards the outside.

In this embodiment, advantageously, the quantity of fluid F dispensed is larger.

Furthermore, this embodiment favours the dispensing of fluids F with high viscosity.

Figures from 23 to 25 show a dispensing system 100 comprising a dispensing device 201 according to another variant embodiment of the invention.

This embodiment differs from the embodiment described above with reference to Figures from 20 to 22 substantially due to the fact that it comprises an anti-dripping device 250.

The anti-dripping device 250 allows the dispensing system 100, when it is in the rest position, meaning the position shown in FIG. 23, to avoid any leakage of fluid F from the dispensing mouth 15.

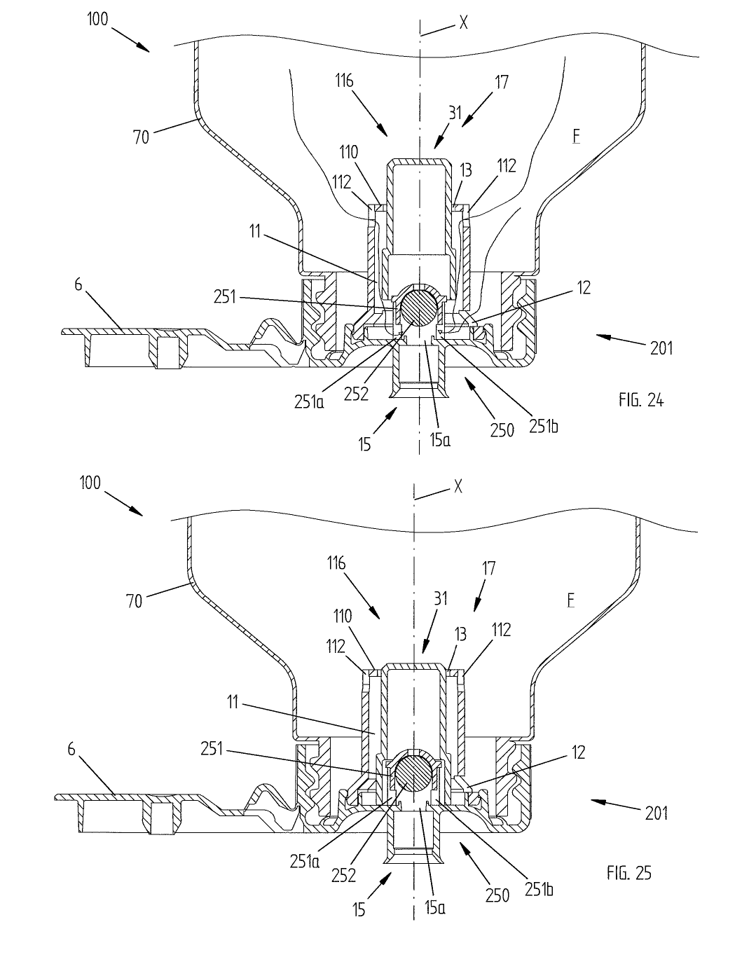

During the dispensing operation, instead, the anti-dripping system 250 allows the fluid to be dispensed through the dispensing mouth 15, as shown in FIGS. 24 and 25.

The function served by the thrusting element 116 is the same previously described.

In particular, the anti-dripping system 250 comprises an element 251 suited to house a ball 252. The housing element 251 is applied at the level of the inner opening 15a of the dispensing mouth 15 and comprises openings 251a, 252a that place the dispensing mouth 15 in communication with the chamber 11. The ball 252 can be arranged inside the housing element 251 in a closing position, as shown in FIG. 23, in which it intercepts and closes the inner opening 15a of the dispensing mouth 15.

This closing position defines the actual anti-dripping position of the system 250.

The ball 252 is then moved inside the housing element 251 during the fluid F dispensing steps, as shown in FIG. 24.

In fact, the fluid F is conveyed from the chamber 11 into the housing element 251 through the openings 251a, 251b. On one side said fluid F is conveyed and dispensed towards the outside through the dispensing mouth 15 while at the same time the same fluid F pushes the ball 252 upwards, thus clearing the inner opening 15a of the dispensing mouth 15.

The dispensing step ends when the thrusting element 116 reaches its end-of-stroke position, shown in FIG. 23, in which the ball 252 is still positioned at the top in the housing element 251.

In the successive release step, not illustrated herein, the thrusting element 116 will return to its initial condition and the ball 252 will return to its closing position, that is, in the configuration shown in FIG. 23.

The ball 252 actually defines a valve means for opening/closing the dispensing mouth 15.

It has thus been shown that the present invention allows all the set objects to be achieved. In particular, the invention achieves the object to provide a dispensing system that is simpler to construct compared to the systems of known type.

While the present invention has been described with reference to the particular embodiments shown in the figures, it should be noted that the present invention is not limited to the specific embodiments illustrated and described herein; on the contrary, further variants of the embodiments described herein fall within the scope of the present invention, which is defined in the claims.

1) Device (1; 101; 201) for dispensing a fluid (F), suited to be applied to a container (70) containing said fluid (F), said device (1; 101; 201) comprising:
a hollow body (10; 10′; 10″) that defines at least one chamber (11) suited to receive and/or allow the transit of a given quantity of said fluid (F) and at least one first opening (12; 12′; 12″; 112) intended to place said chamber (11) in communication with the inside of said container (70) and to allow the passage of said fluid (F);
a dispensing mouth (15) suited to dispense said fluid (F);
a thrusting element (16; 80; 90; 95; 116) slidingly coupled in said chamber (11) and moving along a direction of movement (X) from at least one first rest position to at least one second operating position so as to thrust all or part of said quantity of fluid (F) from said chamber (11) towards said dispensing mouth (15), characterized in that said thrusting element (16; 80; 90; 95; 116) comprises at least one confinement area (20; 81; 91; 96) of a substance different from said fluid (F).

2) Device (1; 101; 201) according to claim 1), characterized in that the density of said substance is lower than the density of said fluid (F).

3) Device (1; 101; 201) according to any of the preceding claims, characterized in that said substance is a gaseous substance.

4) Device (1; 101; 201) according to any of the preceding claims, characterized in that said substance is constituted by air.

5) Device (1; 101; 201) according to any of the preceding claims, characterized in that said confinement area (20; 81; 91; 96) comprises a concave surface of said thrusting element (16; 80; 90; 95; 116).

6) Device according to any of the preceding claims, characterized in that said confinement area (81; 91; 96) is constituted by a closed volume.

7) Device according to claim 6), characterized in that said closed volume comprises a concave surface and a closing element (83; 93) suited to close said concave surface.

8) Device (1; 101; 201) according to any of the preceding claims, characterized in that said hollow body (10; 10′; 10″) comprises at least one second opening (13) that places said chamber (11) in communication with said container (70).

9) Device (1; 101; 201) according to claim 8), characterized in that said thrusting element (16; 80; 90; 95; 116) comprises a first part (17; 82; 92; 97) that is slidingly coupled in said second opening (13) of said hollow body (10; 10′; 10″) and a second part (18; 118) that is slidingly coupled in said chamber (11), said first part (17; 82; 92; 97) of said thrusting element (16; 80; 90; 95; 116) sliding in said at least one second opening (13) of said hollow body (10; 10′; 10″) when said thrusting element (16; 80; 90; 95; 116) is moved along said direction of movement (X).

10) Device (1; 101; 201) according to claim 9), characterized in that the surface area (A1) of said second opening (13) of said hollow body (10; 10′; 10″) is larger than the surface area (A2) of said first part (17; 82; 92; 97) of said thrusting element (16; 80; 90; 95; 116), said surface areas (A1, A2) being measured on a plane that is perpendicular to said direction of movement (X) of said thrusting element (16; 80; 90; 95; 116).

11) Device (1; 101; 201) according to any of the preceding claims, characterized in that said second operating position is an end-of-stroke position of said thrusting element (16; 80; 90; 95; 116).

12) Device (1; 101; 201) according to claim 11), characterized in that in said end-of-stroke position said thrusting element (16; 80; 90; 95; 116) intercepts said dispensing mouth (15).

13) Device (1; 101; 201) according to any of the preceding claims, characterized in that said thrusting element (16; 80; 90; 95; 116) is a piston.

14) Device (1; 101; 201) according to any of the preceding claims, characterized in that it also comprises anti-dripping means (250) suited to allow said dispensing mouth (15) to be closed when said thrusting element (16; 80; 90; 95; 116) is in said first rest position.

15) System for dispensing a fluid (F), comprising a container (70) for said fluid (F) and a device (1; 101; 201) for dispensing said fluid (F) suited to be applied to said container (70), characterized in that said device (1; 101; 201) is made according to any of the preceding claims.
